(19) United States
(12) Patent Application Publication
(10) Pub. No.: US 2025/0138244 A1
(43) Pub. Date: May 1, 2025

(54) MECHANISMS, ASSEMBLIES, AND TOOLS FOR HOLDING A FIBER ACCESS UNIT IN A RECEPTACLE FOR CO-PACKAGED OPTICS

(71) Applicant: CORNING RESEARCH & DEVELOPMENT CORPORATION, CORNING, NY (US)

(72) Inventors: Wojciech Piotr Giziewicz, Berlin (DE); Gordon Mueller-Schlomka, Berlin (DE); Eric Stephan ten Have, Berlin (DE); Bartosz Adam Tylak, Wildau (DE)

(21) Appl. No.: 18/932,055

(22) Filed: Oct. 30, 2024

Related U.S. Application Data
(60) Provisional application No. 63/603,894, filed on Nov. 29, 2023.
(60) Provisional application No. 63/546,658, filed on Oct. 31, 2023.

(51) Int. Cl. G02B 6/30

(52) U.S. Cl. CPC G02B 6/30

(57) ABSTRACT

A mechanism for co-packaged optics includes a receptacle; a frame coupled to the receptacle; and a FAU configured to exert a force on the receptacle such that the FAU is held in place. Various other mechanism, assemblies, and tools for holding a FAU in a receptacle are also disclosed.

### PRIORITY APPLICATION

This application claims the benefit of priority of U.S. Provisional Application Ser. No. 63/603,894 filed Nov. 29, 2023, and U.S. Provisional Application Ser. No. 63/546,658, filed on Oct. 31, 2023, the content of which is relied upon and incorporated herein by reference in its entirety.

### BACKGROUND

The present disclosure generally relates to mechanisms, assemblies, and tools for holding a fiber access unit (alternatively “FAU”), particularly for co-packaged optics.

The growing demand for data and the challenges faced by data centers, such as reducing power consumption and cost per bit, have increased the significance of co-packaged optics (CPO). CPO, which involves integrating optical components and silicon photonics (SiP) on a single packaged substrate, holds great potential in addressing these challenges. In SiP, silicon is used as the optical medium, primarily in the near infrared (NIR) wavelength band around wavelengths of 1.31 μm and 1.55 μm, which are used in telecommunications. Advantages of SiP include the possibility of using existing semiconductor fabrication methods and infrastructure and the integration of electronics and photonics into a single chip as photonic integrated circuits (PICs) or at least into components that work closely together.

While progress has been made in developing components for CPO, the successful implementation of CPO also depends on the design and development of optical system solutions. Specifically, optimizing the complete optical system requires tailoring components and effectively managing and aligning fiber within the packaged substrate.

Managing waveguides plays a role in co-packaged optics. The fiber array unit (FAU), responsible for aligning fibers to waveguides is particularly important in CPO applications. Achieving low coupling losses requires tight positional tolerances and well-centered cores.

One known issue relates to the method of injecting or extracting light into/out of the SiP chips. In telecommunications, light is usually transported in fibers, which now must be coupled to the SiP PICs. Here, three methods can be distinguished: Edge coupling—the waveguides of the SiP chip end and are interfaced with at the edge (side) of the SiP chip. Grating coupling—the PICs use grating couplers as an interface, where the light path is close to perpendicular to the surface of the chip. Grating couplers can be located anywhere on the chip's surface. Evanescent coupling—for evanescent coupling the waveguide in the silicon is brought into close proximity with a glass waveguide, so that the light can couple evanescently from the silicon to the glass and vice versa.

One of the difficulties with coupling light to SiP PICs is the difference in mode field diameters. Single mode fibers have a mode field diameter of about 10 μm, while modes in silicon waveguides may be of submicron dimensions because of the large refractive index of silicon (about 3.5), which leads to high losses if the fibers are coupled directly to the SiP waveguides. To reduce these losses, mode converters are required to scale the modes of the SiP to the size of the fiber modes.

While grating couplers can be designed such that they easily couple to single mode fibers, they have a limited bandwidth, so that they cannot support many different wavelengths (e.g., for WDM applications). Also, the fiber orientation perpendicular to the surface of the chip poses limits on the geometry/arrangements, in which these chips may be used.

Edge couplers require separate mode field converters to be able to couple to fibers. These may be realized in the silicon, as an additional interposer chip, where the conversion is realized through changing the waveguide size along the length, or through imaging optics.

With evanescent coupling, the mode field conversion can already be built into the geometry of the glass waveguides, to which fibers may then directly be coupled.

Accordingly, improved coupling methods, mechanisms, and tools or holding a fiber access unit, particularly for co-packaged optics, are needed.

### SUMMARY

Embodiments disclosed herein are directed to mechanisms, assemblies, and tools for holding a fiber access unit for co-packaged optics. Frequently, FAUs are directly glued to a corresponding surface or held by hinging covers. In some embodiments disclosed herein, a metal frame holds the FAU securely, but releases the FAU when required through a spring with the help of a tool.

Aspects of the embodiments disclosed herein pertain to an alignment and holding mechanism for a receptacle and an FAU. In some embodiments, a metal frame is placed around the receptacle, so that the FAU may be inserted from the top. A lid is then attached to the metal frame from above latching with the fame and exerting a downward and forward force securing the FAU in its optimum position. In one embodiment, the lid may be released by features on the frame such that it pops open, in another embodiment the lid is removed with the help of a tool.

Other disclosed aspects relate to a device/mechanism to securely hold an FAU in a receptacle on a SiP chip. A sheet metal frame is attached to the receptacle, which latches to a sheet metal lid that covers the FAU. The lid provides a downward and forward force to securely hold the FAU in the receptacle.

Advantages of the concepts disclosed herein, include, but are not limited to providing a detachable optical link to a SiP chip; simpler removal/replacement of FAU; and a defined and securely fixed position of the FAU in the receptacle on the SiP chip.

According to one aspect, a mechanism for co-packaged optics includes a receptacle; a frame coupled to the receptacle; and a FAU configured to exert a force on the receptacle such that the FAU is held in place.

Various other mechanism, assemblies, and tools for holding a FAU in a receptacle are also disclosed.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain the principles and operation of the various embodiments.

FIG. 1A is an isometric view of a mechanism for holding an FAU in accordance with embodiments disclosed herein;

FIG. 1B is a side view of the mechanism shown in FIG. 1A;

FIG. 2 is a side view of a mechanism for holding an FAU in accordance with embodiments disclosed herein;

FIG. 3 is a side view of a mechanism for holding an FAU in accordance with embodiments disclosed herein;

FIG. 4A is an isometric view of a mechanism for holding an FAU in accordance with embodiments disclosed herein;

FIG. 4B is a side view of the mechanism shown in FIG. 4A;

FIG. 5A is an isometric view of a mechanism for holding an FAU in accordance with embodiments disclosed herein;

FIG. 5B is a side view of the mechanism shown in FIG. 5A;

FIG. 6A is an isometric view of a mechanism for holding an FAU in accordance with embodiments disclosed herein;

FIG. 6B is a side view of the mechanism shown in FIG. 6A;

FIG. 7A is an isometric view of a mechanism for holding an FAU in accordance with embodiments disclosed herein;

FIG. 7B is a side view of the mechanism shown in FIG. 7A;

FIG. 8A is an isometric view of a mechanism for holding an FAU in accordance with embodiments disclosed herein;

FIG. 8B is a side view of the mechanism shown in FIG. 8A;

FIG. 9A is a partially exploded isometric view of a mechanism for holding an FAU and a tool in accordance with embodiments disclosed herein;

FIG. 9B is a partially exploded isometric view of a mechanism for holding an FAU and a tool in accordance with embodiments disclosed herein; and

FIG. 9C is a partially exploded isometric view of a mechanism for holding an FAU and a tool in accordance with embodiments disclosed herein.

The figures are not necessarily to scale. Like numbers used in the figures may be used to refer to like components. However, it will be understood that the use of a number to refer to a component in a given figure is not intended to limit the component in another figure labeled with the same number.

### DETAILED DESCRIPTION

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not limited to the described exemplary embodiments, but are to be controlled by the limitations set forth in the claims and any equivalents thereof.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

Cartesian coordinates may be used in some of the Figures for reference and are not intended to be limiting as to direction or orientation.

For purposes of description herein, the terms “upper,” “lower,” “right,” “left,” “rear,” “front,” “vertical,” “horizontal,” “top,” “bottom,” “side,” and derivatives thereof, shall relate to the disclosure as oriented with respect to the Cartesian coordinates in the corresponding Figure, unless stated otherwise. However, it is to be understood that the disclosure may assume various alternative orientations, except where expressly specified to the contrary.

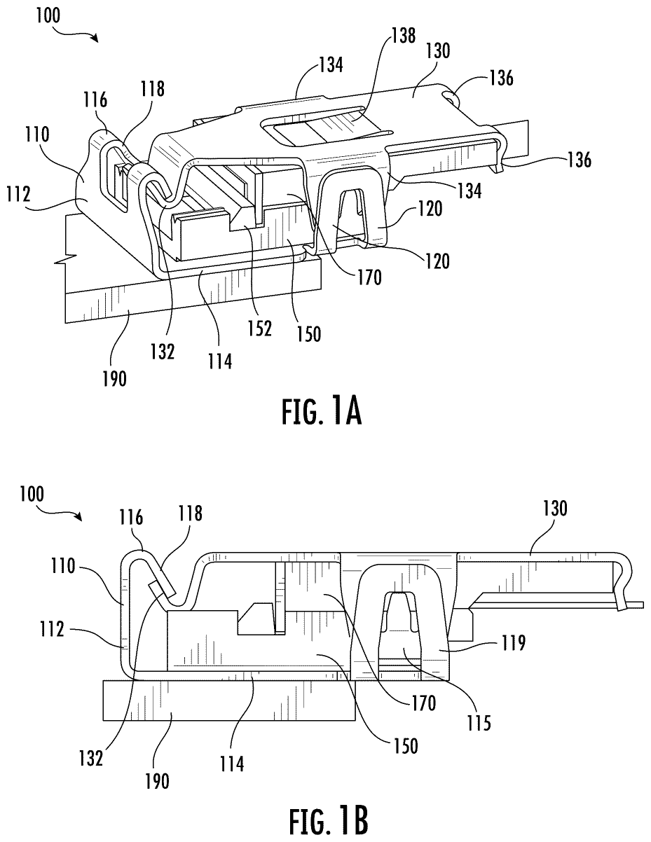

FIGS. 1A and 1B shows an embodiment of a mechanism assembly 100 for holding an FAU 170. The mechanism assembly 100 includes a frame or frame holder 110, a lid element or lid 130, a receptacle 150, and the FAU 170. In both FIGS. 1A and 1B, the mechanism assembly is positioned on a silicon photonic chip 190. The frame 110 includes a frame body 112, having a base 114, a lip element 116, having a bent portion 117 curved to form a hinge-like lip 118, and a plurality of frame latches 120. The receptacle 150 is fitted with the frame 110 such that the receptable is configured to float around the receptacle 150. This positioning can be realized by an opening 115 in the frame that fits the receptacle and allows receptacle and frame to be directly attached to the SiP chip 190 by an adhesive or another type of fastening mechanism, for example. The receptacle 150 may also include an undercut portion 152, so that part of the receptacle extends above the frame 110 to hold it between the receptacle 150 and the SiP chip 190. The frame 150 also includes the hinge-like lip 118 in the front and plurality of side frame latches 120 on the side to hold the lid 130 in position. The lid 130 also preferably has a matching lip 132 in the front, which mates with the frame, and a plurality of lid latches 134 on the sides to engage the frame, as well as a plurality of legs 136 in the back to restrict the backward movement of the FAU. The lid 130 also has a lid spring 138 to push the FAU 170 down into the receptacle 150.

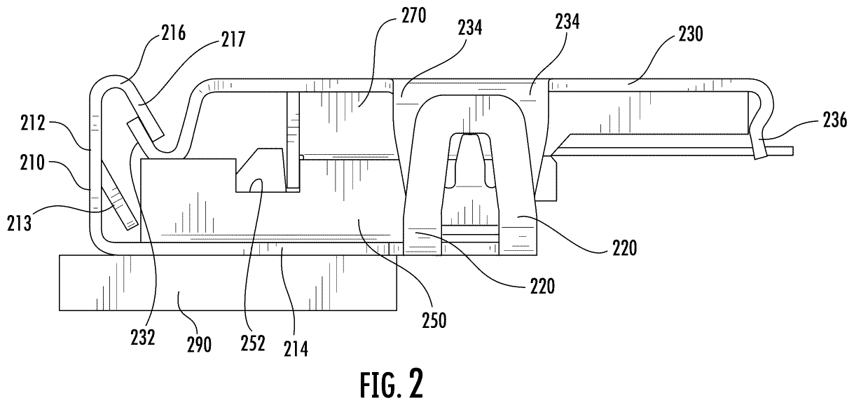

FIG. 2 is a side view of another embodiment of a mechanism assembly 200 for holding an FAU 270. This this embodiment, a frame spring 213 is added in the front part of the frame 210 to push the FAU 270 via the frame 210 and lid 230 towards the front against a hard stop into a defined position. The mechanism assembly 200 includes a frame or frame holder 210, a lid element or lid 230, a receptacle 250, and the FAU 270. The mechanism assembly 200 is positioned on a silicon photonic chip 290. The frame 210 includes a frame body 212, having a base 214, a lip element 216, having a bent portion 217 curved to form a hinge-like lip 218, and a plurality of frame latches 220. As with the first embodiment, the receptacle 250 is fitted with the frame 210 such that the receptable is configured to float around the receptacle 250. This positioning can be realized by an opening 215 in the frame that fits the receptacle and allows receptacle and frame to be directly attached to the SiP chip 290 by an adhesive or another type of fastening mechanism, for example. The receptacle 250 may also include an undercut portion 252, so that part of the receptacle extends above the frame 210 to hold it between the receptacle 250 and the SiP chip 290. The frame 250 also includes the hinge-like lip 218 in the front and plurality of side frame latches 220 on the side to hold the lid 230 in position. The lid 230 also preferably has a matching lip 232 in the front, which mates with the frame, and a plurality of lid latches 234 on the sides to engage the frame, as well as a plurality of legs 236 in the back to restrict the backward movement of the FAU.

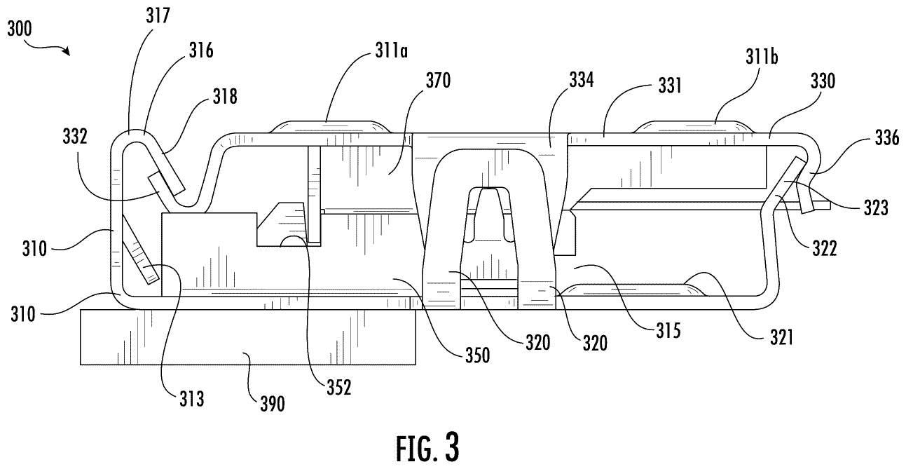

FIG. 3 is a side view of another embodiment of a mechanism assembly 300 for holding an FAU 370. In this embodiment, a frame 310 is extended to the back of the FAU 370. Lid punches 331 are included the lid 330 and frame punches 311a, 311b are added to the frame 310 to increase the stability of the components and prevent flexing. By extending the frame 310, the legs 336 at the end of the lid, there is no longer a need to push against the FAU. Rather, one or more latches are configured for coupling with the frame to provide a more secure hold of the FAU. This embodiment of the frame 310 also includes a rearward frame latch 322, having a latch portion 323 that bends at an angle.

The frame 310 includes a frame body 312, having a base 314, a lip element 316, having a bent portion 317 curved to form a hinge-like lip 318, and a plurality of frame latches 120. The receptacle 350 is fitted with the frame 310 such that the receptable is configured to float around the receptacle 350. The frame spring 313 is also included in the front part of the frame 310 to push the FAU 370 via the frame 310 and lid 330 towards the front against a hard stop into a defined position. This positioning can be realized by an opening 315 in the frame that fits the receptacle and allows receptacle and frame to be directly attached to the SiP chip 390 by an adhesive or another type of fastening mechanism, for example. The receptacle 350 may also include an undercut portion 352, so that part of the receptacle extends above the frame 310 to hold it between the receptacle 350 and the SiP chip 390. The frame 350 also includes the hinge-like lip 318 in the front, a frame punch 321 and plurality of side frame latches 320 on the side to hold the lid 330 in position. The lid 330 also preferably has a matching lip 332 in the front, which mates with the frame, and a plurality of lid latches 334 on the sides to engage the frame, as well as a plurality of legs 336 in the back to restrict the backward movement of the FAU.

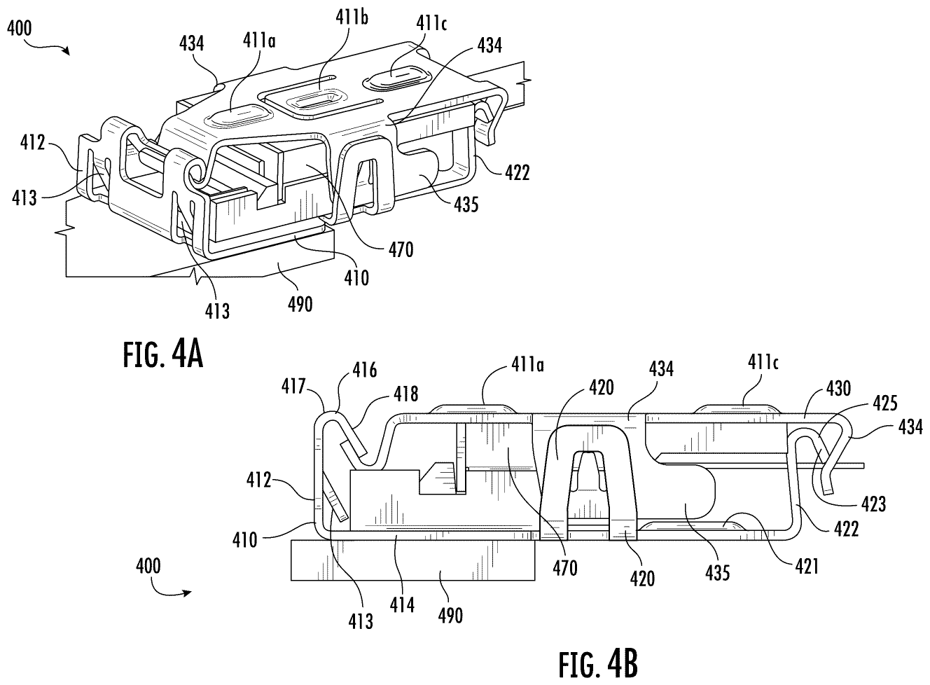

FIGS. 4A and 4B illustrate another embodiment of a mechanism assembly 400 for holding an FAU 470. Here, the rearward frame latch 422 includes a material with spring-like characteristics configured to push the FAU 470 to a forward position. Additionally, one or more lid latches of the plurality of lid latches 434 has extended one or more wings 435 that can be pressed (either manually or by a machine/robot) for an easy release of the lid 430 from the frame 410. Due to the spring force, when unlatched, the lid 430 will pop up automatically, releasing the FAU 470. In this embodiment, the frame 410 is also extended to the back of the FAU 470. Lid punches 431 are included the lid 430 and frame punches 411a, 411b, 411c are added to the frame 410 to increase the stability of the components and prevent flexing. By extending the frame 410, the legs 436 at the end of the lid, there is no longer a need to push against the FAU. Rather, one or more latches are configured for coupling with the frame to provide a more secure hold of the FAU. This embodiment of the frame 410 also includes a rearward frame latch 422, having a latch portion 423 that forms a lip 425 that bends at an angle.

The frame 410 includes a frame body 412, having a base 414, a lip element 416, having a bent portion 417 curved to form a hinge-like lip 418, and a plurality of frame latches 420. The receptacle 450 is fitted with the frame 410 such that the receptable is configured to float around the receptacle 450. The frame spring 413 is also included in the front part of the frame 410 to push the FAU 470 via the frame 410 and lid 430 towards the front against a hard stop into a defined position. This positioning can be realized by an opening 415 in the frame that fits the receptacle and allows receptacle and frame to be directly attached to the SiP chip 490 by an adhesive or another type of fastening mechanism, for example. The receptacle 450 may also include an undercut portion 452, so that part of the receptacle extends above the frame 410 to hold it between the receptacle 450 and the SiP chip 490. The frame 450 also includes the hinge-like lip 418 in the front, a frame punch 421 and plurality of side frame latches 420 on the side to hold the lid 430 in position. The lid 430 also preferably has a matching lip 432 in the front, which mates with the frame, and a plurality of lid latches 434 on the sides to engage the frame, as well as a plurality of legs 436 in the back to restrict the backward movement of the FAU.

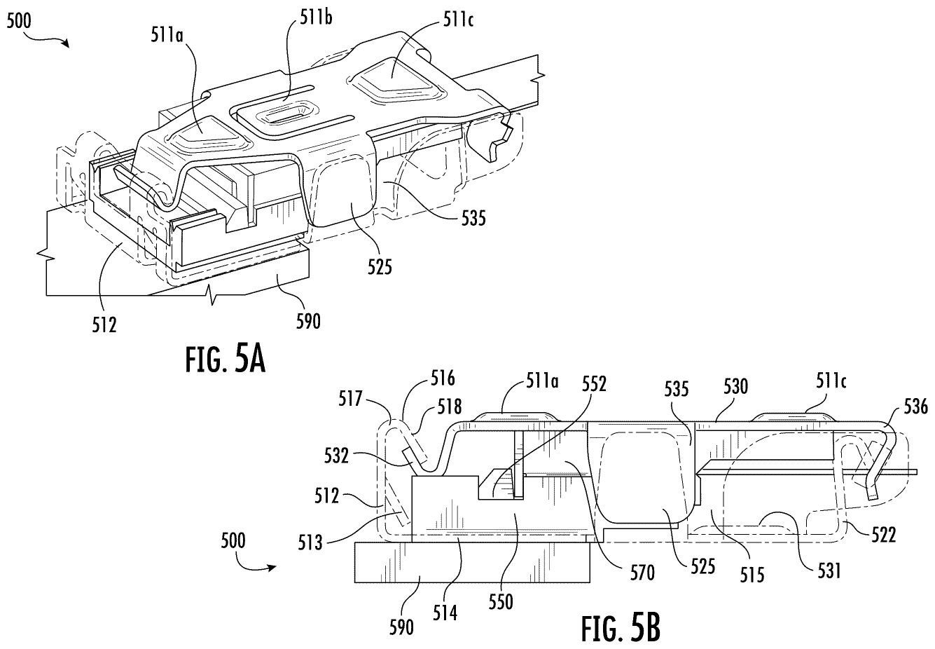

FIGS. 5A and 5B illustrate another embodiment of a mechanism assembly 500 for holding an FAU 570. This embodiment includes alignment wings 525, 535 on the sides instead of latches, as shown in the prior embodiments. Additionally, a locking latch 536 is added and coupled to the rearward latch spring 522, as particularly shown in FIG. 5B. The locking of the latched spring 522 is opened by pushing the side walls apart. This action may be done with a tool, such as cross-locking tweezers, for example. Here, the rearward frame latch 522 includes a material with spring-like characteristics configured to push the FAU 570 to a forward position. Additionally, one or more lid latches of the plurality of lid latches 534 has extended one or more wings 535 that can be pressed (either manually or by a machine/robot) for an easy release of the lid 530 from the frame 510.

Due to the spring force, when unlatched, the lid 530 will pop up automatically, releasing the FAU 570. In this embodiment, the frame 510 is also extended to the back of the FAU 570. Lid punches 511a, 511b, 511c are included the lid 530 and a frame punch 531 are added to the frame 510 to increase the stability of the components and prevent flexing. By extending the frame 510, the legs 536 at the end of the lid, there is no longer a need to push against the FAU. Rather, one or more latches are configured for coupling with the frame to provide a more secure hold of the FAU. This embodiment of the frame 510 also includes a rearward frame latch 522, having a latch portion 523 that forms a lip 525 that bends at an angle.

The frame 510 includes a frame body 512, having a base 514, a lip element 516, having a bent portion 517 curved to form a hinge-like lip 518, and the plurality wings. The receptacle 550 is fitted with the frame 510 such that the receptable is configured to float around the receptacle 550. The frame spring 513 is also included in the front part of the frame 510 to push the FAU 570 via the frame 510 and lid 530 towards the front against a hard stop into a defined position. This positioning can be realized by an opening 515 in the frame that fits the receptacle and allows receptacle and frame to be directly attached to the SiP chip 590 by an adhesive or another type of fastening mechanism, for example. The receptacle 550 may also include an undercut portion 552, so that part of the receptacle extends above the frame 510 to hold it between the receptacle 550 and the SiP chip 590. The frame 550 also includes the hinge-like lip 518 in the front, and a frame punch 531. The lid 530 also preferably has a matching lip 532 in the front, which mates with the frame, and a plurality of wings 535 on the sides to engage the frame, as well as a plurality of legs 536 in the back to restrict backward movement of the FAU.

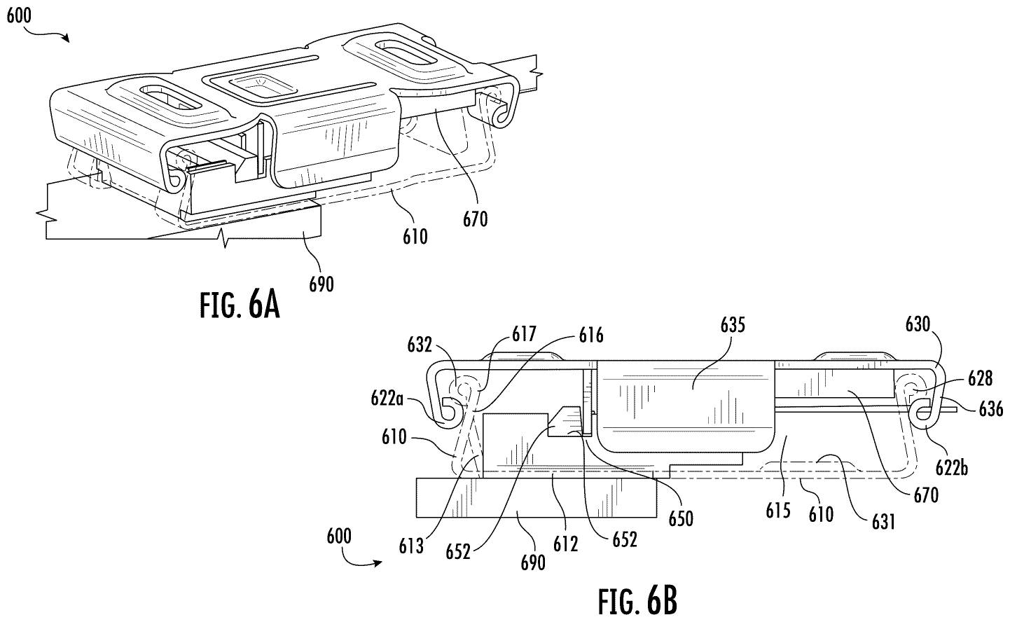

FIGS. 6A and 6B illustrate another embodiment of a mechanism assembly 600 for holding an FAU 670. In this embodiment, an alternative engagement mechanism is configured to attach the lid to the frame with forward and rearward latching springs 622a, 622b. The lid 630 also includes one or more alignment wings 635 that align the lid 630 with the receptacle 650. The frame 610 includes a frame body 612, having a base 614, and a curled lip element 616. The receptacle 650 is fitted with the frame 610 such that the receptable is configured to float around the receptacle 650. The receptacle 650 may also include an undercut portion 652, so that part of the receptacle extends above the frame 610 to hold it between the receptacle 650 and the SiP chip 690. The frame 550 also includes a curled lip element 628 in the rear, and a frame punch 631. The lid 630 also preferably has a matching lip 632 in the front, which mates with the frame, and a plurality of wings 635 on the sides to engage the frame 610, as well as a plurality of legs 636 in the back to restrict backward movement of the FAU.

The frame 610 includes a frame body 612, having a base 614, and a lip element 616, having a curved portion 617. The receptacle 650 is fitted with the frame 610 such that the receptable is configured to float around the receptacle 650. The frame spring 613 is also included in the front part of the frame 610 to push the FAU 670 via the frame 610 and lid 630 towards the front against a hard stop into a defined position. This positioning can be realized by an opening 615 in the frame that fits the receptacle and allows receptacle and frame to be directly attached to the SiP chip 690 by an adhesive or another type of fastening mechanism, for example. The receptacle 650 may also include an undercut portion 652, so that part of the receptacle extends above the frame 610 to hold it between the receptacle 650 and the SiP chip 690. The frame 650 also includes a frame punch 631.

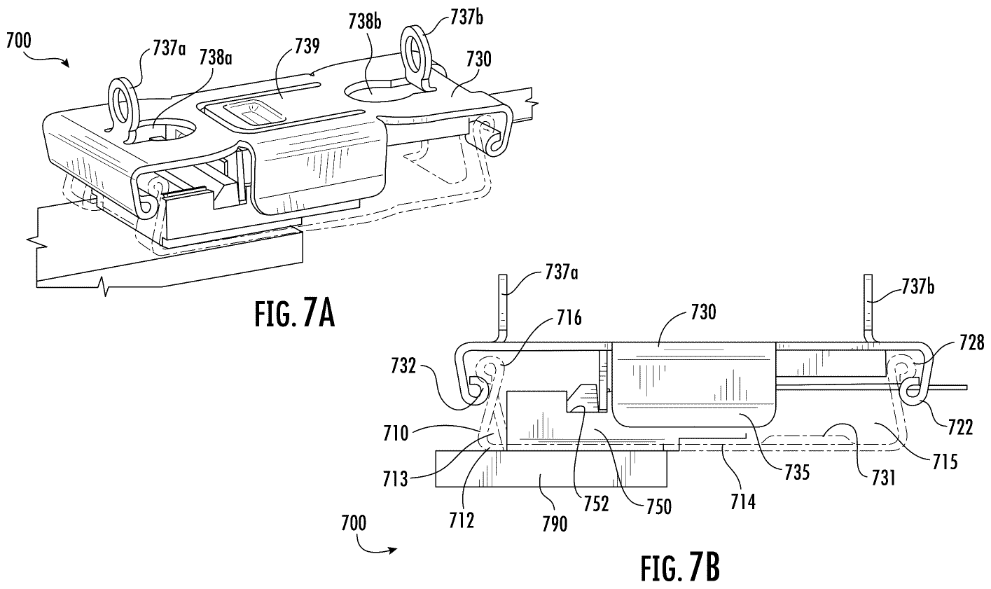

FIGS. 7A and 7B illustrate another embodiment of a mechanism assembly 700 for holding an FAU 770. This embodiment includes a plurality of eyelets 737a, 737b with corresponding apertures 738a, 738b on the top of the lid 730 and a lid punch 739. The eyelets 737a, 737b are preferably oriented vertically. A tool (not shown) is also capable of being inserted from the front and/or back into the eyelets 737a, 737b to pull the lid 730 to an upward position. The lid 730 also includes one or more alignment wings 735 that align the lid 730 with the receptacle 750.

The frame 710 includes a frame body 712, having a base 714, and a curled lip element 716. The receptacle 750 is fitted with the frame 710 such that the receptable is configured to float around the receptacle 750. The receptacle 750 may also include an undercut portion 752, so that part of the receptacle extends above the frame 710 to hold it between the receptacle 750 and the SiP chip 790. The frame 750 also includes a curled lip element 728 in the rear, and a frame punch 731. The lid 730 also preferably has a matching lip 732 in the front, which mates with the frame. The plurality of wings 735 on the sides to engage the frame 710, as well as a plurality of legs 736 in the back to restrict backward movement of the FAU.

The frame 710 includes a frame body 712, having a base 714. The receptacle 750 is fitted with the frame 710 such that the receptable is configured to float around the receptacle 750. The frame spring 713 is also included in the front part of the frame 710 to push the FAU 770 via the frame 710 and lid 730 towards the front against a hard stop into a defined position. This positioning can be realized by an opening 715 in the frame that fits the receptacle and allows receptacle and frame to be directly attached to the SiP chip 790 by an adhesive or another type of fastening mechanism, for example. The receptacle 750 may also include an undercut portion 752, so that part of the receptacle extends above the frame 710 to hold it between the receptacle 750 and the SiP chip 790. The frame 750 also includes a frame punch 731.

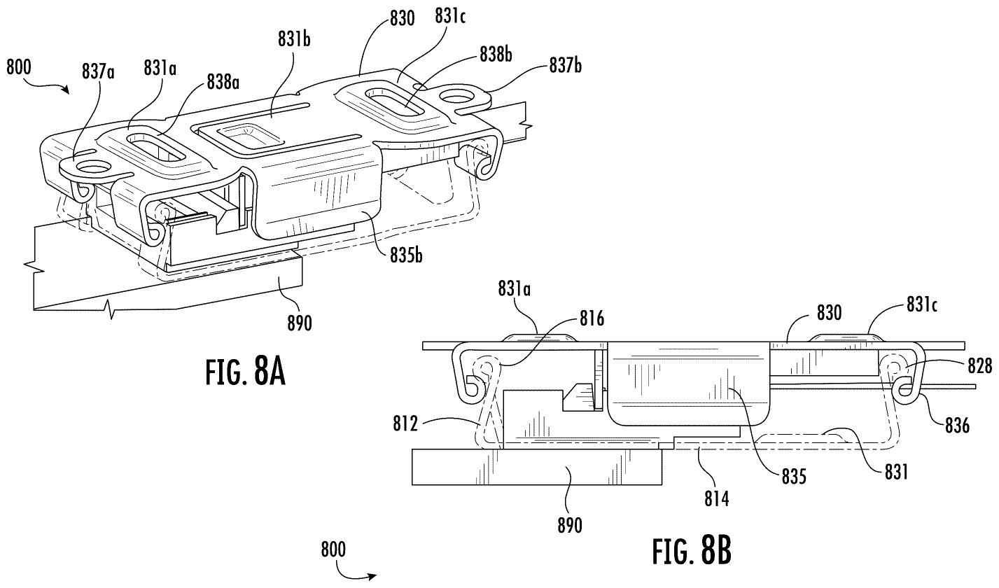

FIGS. 8A and 8B illustrate yet another embodiment of a mechanism assembly 800 for holding an FAU. This embodiment includes eyelets 837a, 837b and apertures 838a, 838b on the top of the lid 830, which are preferably oriented horizontally, and punches 831a, 831b, 831c. A tool (not shown) is also capable of being inserted from above to hook underneath the eyelets and pull the lid up. The lid 830 also includes one or more alignment wings 835 that align the lid 830 with the receptacle 850.

The frame 810 includes a frame body 812, having a base 814, and a curled lip element 816. The receptacle 850 is fitted with the frame 810 such that the receptable is configured to float around the receptacle 850. The receptacle 850 may also include an undercut portion 852, so that part of the receptacle extends above the frame 810 to hold it between the receptacle 850 and the SiP chip 890. The frame 850 also includes a curled lip element 828 in the rear, and a frame punch 831. The lid 830 also preferably has a matching lip 832 in the front, and another lip 822 in the rear, which mates with the frame. The plurality of wings 835 on the sides to engage the frame 810, as well as a plurality of curved legs 836 in the back to restrict backward movement of the FAU.

The frame 810 includes a frame body 812, having a base 814. The receptacle 850 is fitted with the frame 810 such that the receptable is configured to float around the receptacle 850. The frame spring 813 is also included in the front part of the frame 810 to push the FAU 870 via the frame 810 and lid 830 towards the front against a hard stop into a defined position. This positioning can be realized by an opening 815 in the frame that fits the receptacle and allows receptacle and frame to be directly attached to the SiP chip 890 by an adhesive or another type of fastening mechanism, for example. The receptacle 850 may also include an undercut portion 852, so that part of the receptacle extends above the frame 810 to hold it between the receptacle 850 and the SiP chip 890. The frame 850 also includes a frame punch 831.

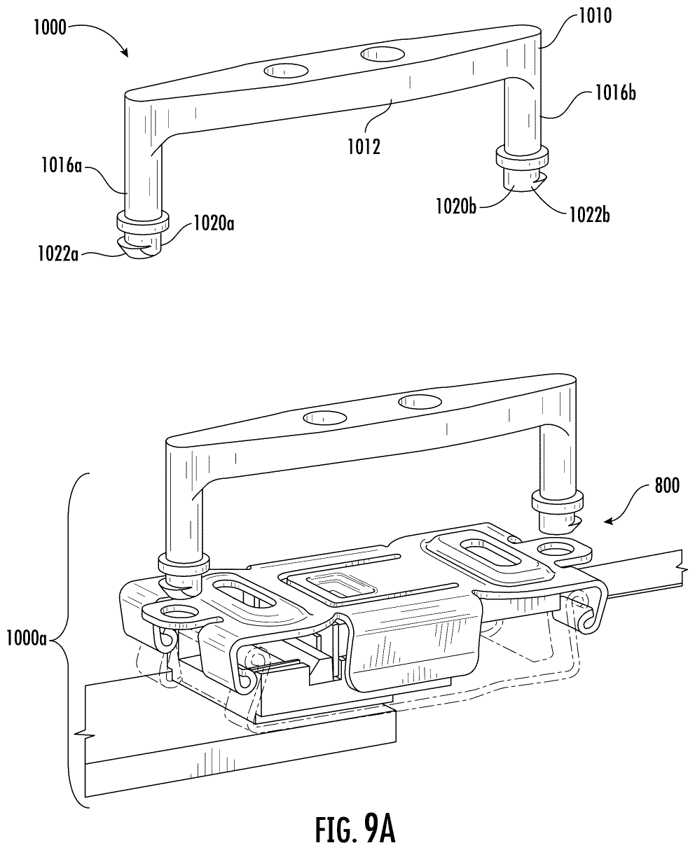

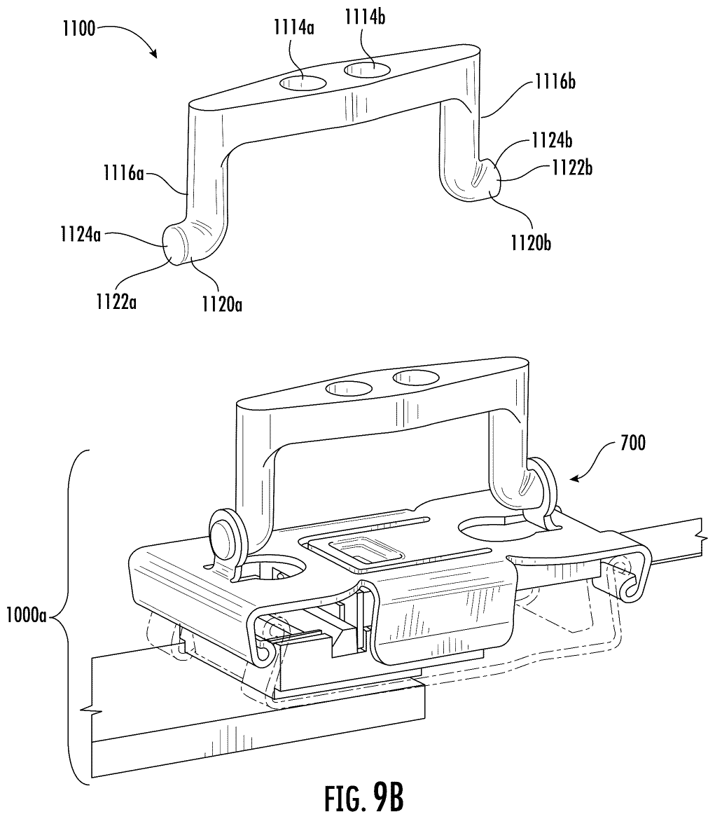

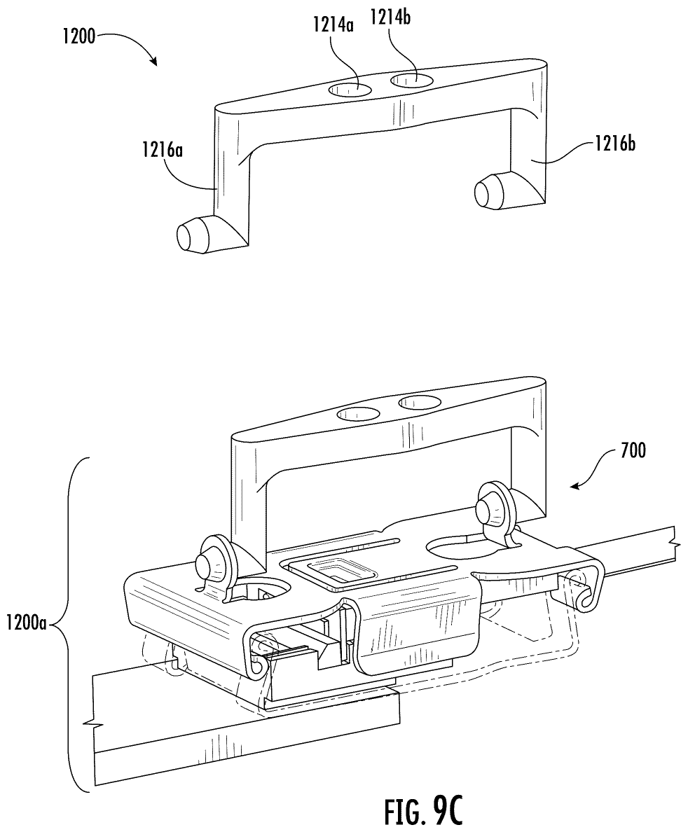

FIG. 9A, 9B, and 9C are partially exploded isometric view of mechanism assemblies 1000, 1100, 1200 for holding an FAU and various tool elements 2000, 2100, 2200 in accordance with the embodiments disclosed herein, having eyelets. Specifically, different conceptions for engaging with the eyelets are shown with either hooking from above (FIG. 9A), coupling to a mechanism assembly 700, or from the front and back (respectively FIGS. 9B and 9C). With respect to the mechanism assembly shown in FIGS. 9B and 9C, the length of the ‘hooks’ must be chosen such that the tool elements may be inserted first into one eyelet and then inserted into the second eyelet without disengaging from the first, i.e., one hook is preferably longer than the other and the distance between vertical legs is preferably smaller than the distance between the eyelets, while the distance between the tips of the hooks is longer than the distance between the eyelets.

Referring to FIG. 9A-9C, which couples to mechanism assembly 800, each tool includes a tool body with a central portion, having openings disposed therein, a plurality of arms, extending downwardly and perpendicular to the central portion, and a plurality of engagement elements. Referring to FIG. 9A, extending substantially perpendicular to the central portion 1010 are a plurality of arms 1016a, 1016b. Extending from each arm are tool engagement elements 1020a, 1020b, having threads 1022a, 1022b. FIG. 9A further shows the central portion 1012 having openings 1014a, 104b disposed therein.

Referring to FIG. 9B, extending substantially perpendicular to the central portion 1110 are a plurality of arms 1116a, 1116b. Extending from each arm are tool engagement elements 1020a, 1020b, having outwardly extending hook elements 1122a, 1122b with flat ends 1124a, 1124b. FIG. 9C further shows the tool body 1210 with the central portion 1212, having openings 1214a, 1214b disposed therein.

Referring to FIG. 9C, extending substantially perpendicular to the central portion 1210 are a plurality of arms 1216a, 1216b. Extending from each arm are tool engagement elements 1220a, 1220b, having outwardly extending hook elements 1222a, 1222b with chamfered ends 1224a, 1224b. FIG. 9C further shows a tool body 1210 with the central portion 1212, having openings 1214a, 1214b disposed therein.

Features of the concepts disclosed herein include, but are not limited to providing a frame around receptacle, either fixed to SiP chip or floating around receptacle; a lid to hold FAU in receptacle; a hinge-like interlocking lips in front; latches on the sides and/or back; alignment wings on the sides; springs in the front, top, and/or back; punches in lid, frame, and top spring for stability (round, oblong, trapezoid, etc.); wings to easily disengage via latches or a receptacle; locking mechanism to secure latches; latched springs; eyelets in lid (vertical, horizontal, in front, back, center, sides, etc.). Moreover, a lifting tool may be used with any of the mechanisms disclosed herein either manually or automatically, using a machine or robot.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A mechanism assembly for co-packaged optics, comprising:
a receptacle;
a frame coupled to the receptacle; and
an FAU configured to exert a force on the receptacle such that the FAU is held in place.

2. The mechanism assembly of claim 1, further comprising a lid configured to hold the FAU in the receptacle.

3. A mechanism assembly for co-packaged optics, comprising:
a FAU;
a frame coupled to the FAU; and
a receptacle configured to hold the FAU such that the FAU is configured for positioning into the receptacle on a SiP chip.

4. The mechanism assembly of claim 3, wherein the frame is attached to at least one SiP chip.

5. The mechanism assembly of claim 3, wherein the frame is configured to float around the receptacle.

6. The mechanism assembly of claim 3, further comprising a lid configured to hold the FAU in the receptacle.

7. The mechanism assembly of claim 3, further comprising interlocking lips coupled to the frame.

8. The mechanism assembly of claim 3, further comprising interlocking latches coupled to the frame.

9. The mechanism assembly of claim 3, further comprising at least one spring coupled to the frame.

10. The mechanism assembly of claim 6, wherein the lid comprises a plurality of punches.

11. The assembly of claim 3, further comprising at least one alignment wing coupled to the frame.

12. The assembly of claim 3, further comprising at least one locking mechanism coupled to the frame.

13. The assembly of claim 12, wherein the at least one locking mechanism is configured to secure one or more latches.

14. The assembly of claim 3, further comprising at least one latched spring mechanism coupled to the frame.

15. The assembly of claim 6, wherein the lid includes a plurality of eyelets defined therein.

16. The assembly of claim 15, wherein at least some of the plurality of eyelets are positioned vertically.

17. The assembly of claim 15, wherein at least some of the plurality of eyelets are positioned horizontally.

18. The mechanism assembly of claim 15, further comprising a tool inserted into at least one of the plurality of eyelets.

19. The mechanism assembly of claim 18, wherein the tool is removable from the eyelets.

20. A method of inserting a tool into a mechanism assembly, comprising:
positioning a portion of a tool into an eyelet defined in the mechanism assembly.
